(19) United States
(12) Patent Application Publication
(10) Pub. No.: US 2026/0187694 A1
(43) Pub. Date: Jul. 2, 2026

(54) PERSONALIZED PARTS EXPERIENCES ON LISTING PLATFORMS

(71) Applicant: eBay Inc., San Jose, CA (US)

(72) Inventors: Sachin Joshi, San Jose, CA (US); Rajkumar Varadharajan, Cupertino, CA (US)

(21) Appl. No.: 19/007,154

(22) Filed: Dec. 31, 2024

(51) Int. Cl. G06Q 30/0601

(52) U.S. Cl. CPC G06Q 30/0631; G06Q 30/0633

(57) ABSTRACT

Some aspects relate to technologies for providing personalized parts experiences to users on listing platforms. In accordance with some aspects, signal data is accessed for a user of a listing platform based on user interactions of the user on the listing platform that are associated with parts and/or applications. Signal classifications are determined for the signal data to provide classified signal data for the user. One or more user classifications for the user are then determined based on the classified signal data. At least one of those user classifications is used to select a personalized parts experience for the user. One or more application servers of the listing platform then provide the personalized parts experience to a user device of the user via one or more user interfaces presented on the user device.

### BACKGROUND

Listing platforms, such as e-commerce websites, are online platforms that offer items (e.g., products) to users by providing user interfaces to user devices to allow users to find item listings for items to purchase. Such listing platforms typically offer a vast number of item listings, with each item listing offering a particular item for sale. Managing such a large number of item listings is a technical challenge for listing platforms. On the buyer side, while some item listings are relevant to any given buyer, the majority is not. As a result, item retrieval for listing platforms is a particular Internet-centric problem that has proven to be difficult to fully address. That is, given a large number of item listings available on a listing platform, what item listings should be retrieved and presented to a given buyer. On the seller side, some listing platforms have third-party sellers, who can each have their own large inventory of item listings. Providing relevant information and features to sellers to allow the sellers to effectively manage their inventory is also a technical challenge for listing platforms. These challenges are increased when dealing with parts that require compatibility with other items.

### SUMMARY

Some aspects of the present technology relate to, among other things, a listing platform that provides personalized parts experiences to buyer users and/or seller users of the listing platform. In accordance with some aspects, the listing platform tracks signal data for a user that involves parts and/or applications (i.e., items to which parts must be compatible with). The signal data can include, for instance, information provided to the listing platform by the user and information regarding user behavior on the listing platform. The signal data is classified into predefined signal classifications to provide classified signal data. Based on the classified signal data for the user, the listing platform determines one or more user classifications for the user. A personalized parts experience is selected based on at least one of these user classifications. Application servers of the listing platform then provide the selected personalized parts experience to a user device of the user. The personalized parts experience can include, for instance, providing parts-relevant content, user interface elements, and/or features/services.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a diagram showing example signal classifications in accordance with some implementations of the present disclosure;

FIG. 3 is a diagram showing example user classifications based on classified signal data in accordance with some implementations of the present disclosure;

FIG. 4 is a diagram showing example personalized parts experiences based on user classifications in accordance with some implementations of the present disclosure;

FIG. 5 is a block diagram showing an example process for providing a personalized parts experience for a user in accordance with some implementations of the present disclosure;

FIG. 6 is a flow diagram showing a method for providing a personalized parts experience to a user of a listing platform in accordance with some implementations of the present disclosure; and

FIG. 7 is a block diagram of an exemplary computing environment suitable for use in implementations of the present disclosure.

### DETAILED DESCRIPTION

### Overview

Many listing platforms (e.g., e-commerce websites) offer a large number of item listings and also serve a large number of visitors. For instance, it has been reported that as of 2023, the eBay listing platform has 1.7 billion item listings, and the monthly number of visits to eBay websites reached almost 3 billion. Each user visit to the website of a listing platform by a buyer user involves servers of the listing platform processing user inputs and providing, over a network, digital content to a user device of the buyer user as the buyer user navigates the website. This can include, for instance, providing search result pages in response to search input, browse node pages in response to users browsing the website or navigation from external sources, and item pages when users select to view information for particular item listings.

Given the vast number of available item listings and user visits, listing platforms require significant server resources to ensure smooth performance and quick load times, even during peak traffic periods, as well as advanced database management systems to efficiently organize and retrieve item listing information. As a result, listing platforms demand extensive server processing and storage resources to handle the dynamic and high-demand environment effectively. Many listing platform providers attempt to design their server systems to provide relevant item listings to users as quickly and efficiently as possible in order to reduce the computing resource consumption required for the user visits. For instance, if the search system of the listing platform is ineffective in returning relevant search results, buyer users will submit additional search queries until relevant search results are returned. These repetitive search queries can exponentially increase the computer resource consumption of the listing platform (e.g., increased bandwidth, memory, and CPU usage). Additionally, buyer users often repeatedly select to view item pages for different item listings until they find relevant items. This requires the servers of the listing platform to repeatedly retrieve data from storage and provide the item pages to the user devices, also increasing computer resource consumption.

Listing platforms also face significant technical challenges in delivering relevant information and features to third-party sellers for inventory management. These platforms must process vast amounts of data in real-time, including inventory levels, pricing, sales trends, and order updates, to ensure sellers have up-to-date insights. Additionally, supporting diverse seller needs requires developing scalable tools that cater to varying business models, product categories, and sales volumes. The complexity increases with the integration of third-party software, real-time synchronization, and user-customizable interfaces. These demands often result in inefficient use of computational resources, such as over-provisioned servers, redundant data processing, and poorly optimized algorithms. Such inefficiencies lead to increased operational costs, slower system performance, and suboptimal user experiences for both seller users and buyer users.

One area that presents a particular challenge for listing platforms is dealing with item listings for parts (sometimes referred to as part item listings). Parts are items specifically designed to be compatible with certain applications, ensuring they fit and function correctly within a larger system. For example, an ink cartridge is a part that must be compatible with a particular model of printer (i.e., the application) to ensure proper printing performance. The term “part” is used herein to refer to any item that involves compatibility, including required parts and optional accessories. The compatibility requirement for parts presents a significant challenge for listing platforms, as parts must be matched with the correct applications. This increases the difficulty in surfacing relevant content to enable buyer users to efficiently find items of interest and to enable seller users to efficiently manage their inventories.

Aspects of the technology described herein improve the functioning of server systems for listing platforms by providing personalized parts experiences on listing platforms to buyer users and/or seller users. As used herein, a personalized parts experience on a listing platform involves one or more application servers of the listing platform providing tailored information and/or interactions regarding parts and applications to user devices of users. This can include, for instance, providing customized content presentation for parts on the listing platform, such as relevant search results, item recommendations, and informational articles. This can also include providing specialized user interface elements like enhanced search options and filters. This can further include enabling certain features, such as enhanced inventory reporting functionality and management tools.

In accordance with some aspects, the listing platform monitors and records various types of signal data generated by users as they interact with the listing platform. For buyer users, this can include, for instance, tracking information provided by the buyer users (e.g., applications owned) and tracking user behavior (e.g., search queries, browsing history, items viewed, items added to wish lists or carts, reviews and ratings submitted, chat messages with sellers, purchases made, items returned, etc.). For seller users, this can include tracking inventory information (e.g., inventory details, buyer interactions with listed items, sales data, advertising performance, sales metrics, etc.) and tracking user behavior (e.g., advertising keyword bids, reports accessed, etc.). The signal data can be tracked, for instance, via server logs, cookies, and web beacons to capture user interactions and integrate with user accounts to maintain a comprehensive view of user behavior over time.

The listing platform processes the signal data collected for a user and categorizes it into predefined signal classifications to create classified signal data. The signal classification can be achieved, for instance, using rule-based algorithms or machine learning techniques. Rule-based algorithms use predefined rules to map signal data to specific signal classifications, while machine learning techniques involve training one or more signal classifier models to take various types of signal data as input and output relevant signal classifications. In some aspects, different portions of the classified signal data for a given user can correspond to different applications and/or different types of parts.

The listing platform utilizes the classified signal data for a user to determine one or more user classifications for the user. The user classification can involve rule-based algorithms or machine learning models. Rule-based algorithms apply predefined rules to the classified signal data to assign user classification(s), while machine learning techniques involve training one or more user classifier models to take various types of classified signal data as input and output relevant user classifications. In some aspects, the listing platform can determine a number of different user classifications for a user that correspond to different applications and/or different types of parts.

The listing platform leverages at least one user classification for a user to select and provide a personalized parts experiences to the user when the user interacts with the listing platform. This can include using one or more rule-based algorithms that map particular user classifications to particular personalized parts experiences. Once a personalized parts experience is selected for a user, application servers of the listing platform deliver this personalized parts experience to a user device of the user. This can include, for instance, providing customized content, user interface elements, and/or features/services. In some aspects, the listing platform can select the personalized parts experience based on the user's current context on the listing platform. For instance, if the user has user classifications corresponding to different applications and/or types of parts, the listing platform can determine a current context of the user as corresponding to a particular application and/or type of part, identify a corresponding user classification for that application/type of part, and provide a personalized parts experience based on that user classification. The listing platform can also dynamically adjust the personalized parts experience as the user's context on the listing platform changes.

Aspects of the technology described herein provide a number of improvements for server systems of listing platforms. For instance, the technology described herein offers significant technical advantages by optimizing the efficiency and effectiveness of listing platforms'server systems. By providing personalized parts experiences, the technology described herein reduces the number of user inputs and corresponding server responses required for buyer users to find relevant items and for seller users to manage their inventories. For instance, the personalized parts experiences provided to buyer users enable the buyer users to more efficiently access relevant item listings on the listing platform, thereby reducing user inputs, such as search queries submitted, user browsing, and item listing views. For seller users, the personalized parts experiences enable the listing platform to more efficiently provide inventory-related information that is relevant to each seller user, reducing user inputs required to obtain such information. Accordingly, the technology described herein, among other things, reduces the number of user inputs (e.g., requests for item pages, search input, browse node navigations, metrics, reports, etc.) and corresponding responses processed by the server systems of the listing platform. Given the number of item listings available on listing platforms and the number of user visits, this technology significantly reduces the computer resource consumption (e.g., bandwidth, memory, and CPU usage) for the server systems and improves overall performance.

### Example System for Personalized Parts Experience on a Listing Platform

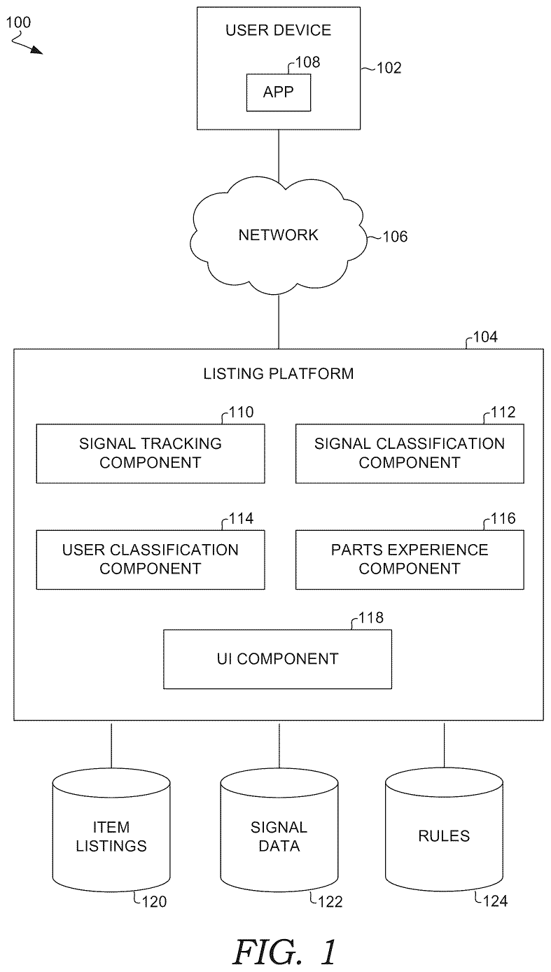

With reference now to the drawings, FIG. 1 is a block diagram illustrating an exemplary system 100 for providing personalized parts experiences to users of listing platforms in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

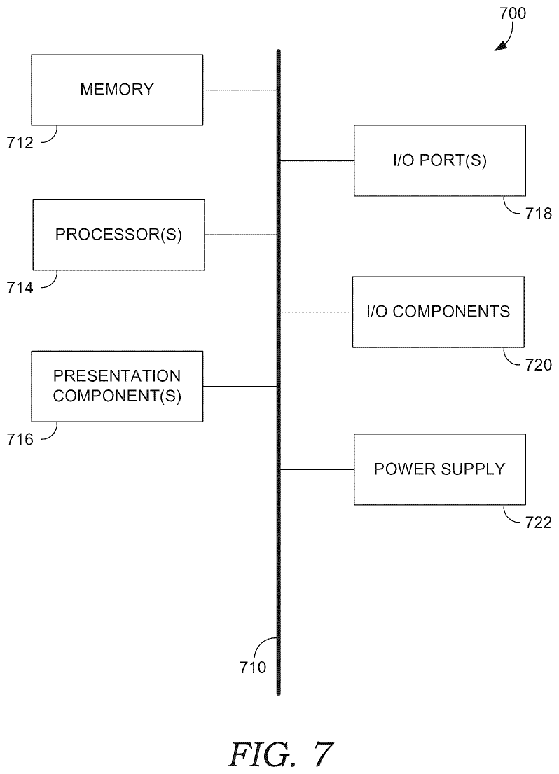

The system 100 is an example of a suitable architecture for implementing certain aspects of the present disclosure. Among other components not shown, the system 100 includes a user device 102 and a listing platform 104. Each of the user device 102 and the listing platform 104 shown in FIG. 1 can comprise one or more computer devices, such as the computing device 700 of FIG. 7, discussed below. As shown in FIG. 1, the user device 102 and the listing platform 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each can comprise a single device or multiple devices cooperating in a distributed environment. For instance, the listing platform 104 could be provided by multiple server devices collectively providing the functionality of the listing platform 104 as described herein. Additionally, other components not shown may also be included within the network environment.

The user device 102 can be a client device on the client-side of the system 100, while the listing platform 104 can be on the server-side of the system 100. The listing platform 104 can comprise server-side software designed to work in conjunction with client-side software on the user device 102 so as to implement any combination of the features and functionalities discussed in the present disclosure. For instance, the user device 102 can include an application 108 for interacting with the listing platform 104. The application 108 can be, for instance, a web browser or a dedicated application for providing functions, such as those described herein. This division of the system 100 is provided to illustrate one example of a suitable environment, and there is no requirement for each implementation that any combination of the user device 102 and the listing platform 104 remain as separate entities. While the system 100 illustrates a configuration in a networked environment with a separate user device and content server, it should be understood that other configurations can be employed in which aspects of the various components are combined. For instance, in some aspects, aspects of the listing platform 104 can be implemented at least in part by the user device 102 and vice versa.

The user device 102 may comprise any type of computing device capable of use by a user. For example, in one aspect, a user device may be the type of computing device 700 described in relation to FIG. 7 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user (e.g., a buyer user or a seller user) may be associated with the user device 102 and may interact with the listing platform 104 via the user device 102.

As shown in FIG. 1, the listing platform 104 includes a signal tracking component 110, a signal classification component 112, a user classification component 114, a parts experience component 116, and a user interface component 118. The components of the listing platform 104 may be in addition to other components that provide further additional functions beyond the features described herein. The listing platform 104 can be implemented using one or more server devices, one or more platforms with corresponding application programming interfaces, cloud infrastructure, and the like. While the listing platform 104 is shown separate from the user device 102 in the configuration of FIG. 1, it should be understood that in other configurations, some of the functions and/or components of the listing platform 104 can be provided on the user device 102 or another location not shown in FIG. 1. The components can be provided by a single entity or multiple entities.

In some aspects, the functions performed by components of the listing platform 104 are associated with one or more applications, services, or routines. In particular, such applications, services, or routines may operate on one or more user devices, servers, may be distributed across one or more user devices and servers, or be implemented in the cloud. Moreover, in some aspects, these components of the listing platform 104 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The listing platform 104 generally provides, to user devices such as the user device 102, item listings describing items available for purchase using the listing platform 104. For instance, the listing platform 104 could comprise an e-commerce platform, in which listed products are available for purchase by users of user devices upon navigation to a website of the listing platform 104. The functionality of the listing platform 104 includes provision of interfaces (e.g., via the user interface component 118) enabling surfacing of item listings for items to users of the listing platform 104. Data for item listings of items available for sale via the listing platform 104 is stored by the item listings data store 120. The data for each item listing can include a description relating to an item comprising one or more of: a price in a currency, reviews, images of the item, shipment options, a rating, a condition of the item, a size of the item, a color of the item, etc. Each item listing for a part (i.e., a part item listing) can also include fitment data, which refers to information regarding compatibility of the part with a relevant application. For instance, the fitment data for a vehicle part can include the year, make, and model of each vehicle with which the part is compatible. In aspects, each item listing is also associated with one or more item categories from a pre-defined category hierarchy for the listing platform 104, including meta-categories and leaf categories. For example, the meta-categories are each divisible into subcategories (or branch categories), whereas leaf categories are not divisible.

The signal tracking component 110 of the listing platform 104 monitors and records various signal data generated by users interacting with the listing platform 104. The signal data tracked can vary based on the type of user. By way of example only and not limitation, for a buyer user, the signal tracking component tracks signal data regarding user behavior of the buyer user on the listing platform 104, such as: search queries submitted, browsing history, item listings viewed, item listings added to wish lists, item listings added to carts, reviews and ratings submitted for items, chat messages with seller users, items purchased, prices of items purchased, number of purchases, frequency of purchases, and items returned. The signal data tracked for a buyer user can also include information regarding items owned by the user, including applications and/or parts. This can include information identifying owned items that the buyer user has explicitly provided to the listing platform 104 and/or information regarding items the buyer user has purchased from the listing platform 104. For example, owned items for a buyer user could include an indication of a year/make/model of one or more vehicles that the buyer user has indicated as owned, as well as parts for each vehicle the buyer user has purchased from the listing platform 104.

In the case of a seller user, the signal data can include, for instance, information regarding the seller user's inventory, such as: items the seller user has listed for sale on the listing platform 104, buyer interaction information for items from the seller user's inventory (e.g., item listing views, reviews and ratings, etc.), inventory levels, number of sales of each item, frequency of sales of each item, and returns/refunds. The signal data for a seller user can also include information regarding user behavior of the seller user on the listing platform 104, such as: advertising keywords bid on for promoted placement of the seller user's item listings (e.g., in search results or item recommendations), chat messages with buyer users, and seller metrics viewed by the seller user.

The signal tracking component 110 can be implemented using various tracking technologies, such as server logs, cookies, and web beacons, to capture user interactions with the listing platform 104. Additionally, the signal tracking component 110 can integrate with user accounts on the listing platform 104 to track historical data and provide a comprehensive view of user behavior over time. In some configurations, signal data for each user can be stored in a signal data store 122 for use by downstream components of the listing platform 104. The signal data for each user can be stored in association with a user identifier for the user to facilitate identifying relevant signal data for each user. In some instances, the signal data can be stored as part of a user profile of each user maintained by the listing platform 104.

The signal classification component 112 processes the signal data collected by the signal tracking component 110 and categorizes it into pre-defined signal classifications to provide classified signal data. This can be achieved using rule-based algorithms and/or machine learning techniques. When using rule-based algorithms, the rules used by the signal classification component 112 can be accessed from a rules data store 124 or the rules can be embedded in the code of the signal classification component 112. The rules can define different types of signal classifications for different types of signal data. For example, a rule could employ signal data identifying make/model of vehicles owned by buyer users and map each to a signal classification that represents the type of vehicle (e.g., vintage vehicle, high-performance vehicle, commuter vehicle, etc.).

When using machine learning techniques, the signal classification component 112 employs one or more signal classifier models to classify signal data into pre-defined signal classifications to provide classified signal data. A signal classifier model can comprise, for instance, a neural network model (i.e., an artificial neural network, ANN) that has been trained to take as input one or more different types of signal data and to output a signal classification based the input signal data. In some aspects, multiple signal classifier models are employed where each signal classifier model takes different signal data as input to generate different types of signal classifications. For instance, a signal classifier model could operate on signal data involving a combination of a buyer user's vehicle make/model with the buyer user's interactions with various parts for that vehicle make/model to determine a signal classification that relates to a parts category expertise level. As another example, a signal classifier model could operate on signal data involving purchases made by the buyer user (e.g., number of items purchased, frequency of purchases) to determine a signal classification that relates to a purchase pattern.

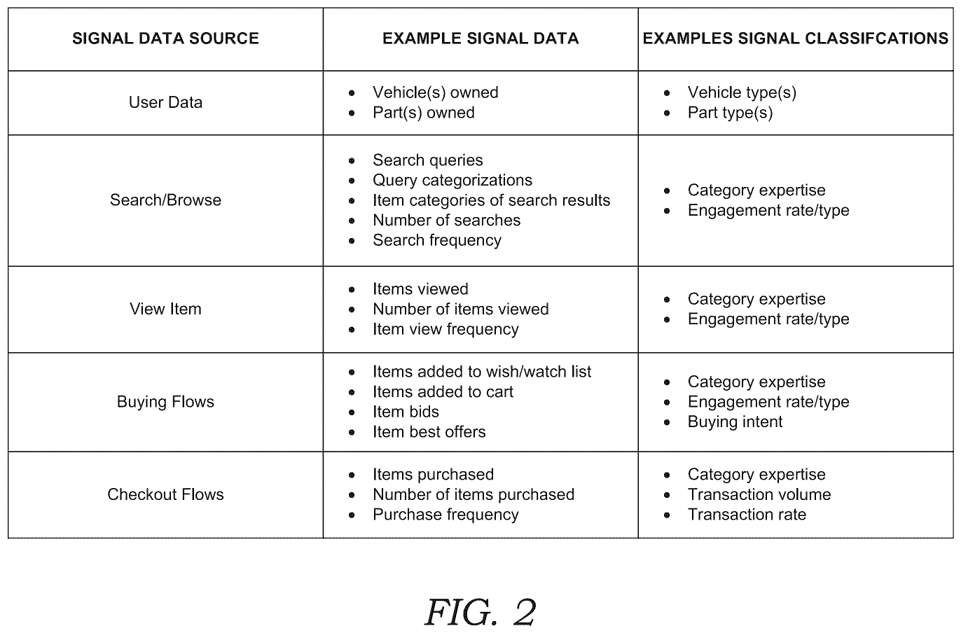

By way of illustration, FIG. 2 provides a diagram showing examples of different types of signal data for buyer users and different types of signal classifications that can be determined by the signal classification component 112 based on that signal data in the context of vehicles and vehicle parts. As can be seen from the examples shown in FIG. 2, a variety of different types of signal data can be collected from different sources, such as user data, search/browse, view item, buying flows, and checkout flows. Additionally, the signal data can be classified into a variety of different types of signal classifications. Some signal classification types can correspond to a single signal data source. For instance, a vehicle type signal classification corresponds to signal data regarding a vehicle owned by the buyer user, while a buying intent signal classification corresponds to signal data from buying flows. Other signal classification types can correspond to multiple signal data sources. For instance, a category expertise classification can correspond to search/browse signal data, item view signal data, buying flows signal data, and checkout flows signal data.

The user classification component 114 utilizes the classified signal data for users to determine user classifications for each user. The user classification component 114 can determine any number of different user classifications for a given user based on the available classified signal data for that user. The user classifications can be determined using rule-based algorithms and/or machine learning techniques. When using rule-based algorithms, the rules used by the user classification component 114 can be accessed from the rules data store 124 or the rules can be embedded in the code of the user classification component 114. The rules can define different types of classified signal data to use to determine different types of user classifications. For example, a rule could employ signal data classified as category expertise level to determine an expertise classification for the buyer user.

When using machine-learning models, the user classification component 114 employs one or more user classifier models to classify signal classifications for the user into predefined user classifications. A user classifier model can comprise, for instance, a neural network model that has been trained to take as input one or more different types of classified signal data from the signal classification component 112 and to output a user classification based the input. In some aspects, multiple user classifier models are employed where each user classifier model takes particular classified signal data as input to output a particular type of user classification. For instance, one user classifier model could be employed to determine an expertise user classification based on certain classified signal data, while another user classifier model could be employed to determine a purchase pattern user classification based on other classified signal data.

In some aspects, the user classification component 114 can determine different user classifications for a given user associated with different applications. For example, suppose a buyer user owns two vehicles: a vintage car and a commuter car. The classified signal data for the buyer user could be associated with one or the other of those vehicles, such that there are two sets of classified signal data for the buyer user: a first set of classified signal data associated with the vintage car and a second set of classified signal data for the commuter car. Accordingly, the user classification component 114 can determine a first set of one or more user classifications for the buyer user that are associated with the vintage car and a second set of one or more user classifications for the buyer user that are associated with the commuter car. This reflects that users can exhibit different behavior patterns on the listing platform 104 for different owned applications. The user classification component 114 can differentiate between these application contexts and assign appropriate user classifications for the different applications owned by the user.

The user classification component 114 can also determine different user classifications for a given user associated with different categories of parts. In some aspects, a user classification for a given parts category can be based on classified signal data for that parts category across different applications. For example, suppose again that a buyer user owns two vehicles: a vintage car and a commuter car. The user classification component 114 could determine a user classification for the buyer user for a tires parts category based on classified signal data related to tires for both vehicles. In other aspects, different user classifications can be determined for a user for different parts categories for a single application. For example, in the case the buyer user owns two vehicles (i.e., a vintage care and a commuter car), the classified signal data for the vintage car could include a first set of classified signal data associated with a first parts category (e.g., oil) and a second set of classified signal data association associated with a second parts category (e.g., bumpers and grills). Accordingly, the user classification component 114 can determine a first set of one or more user classifications for the buyer user that are associated with the first parts category and a second set of one or more user classifications for the buyer user that are associated with the second parts category. This reflects that users can exhibit different behavior patterns on the listing platform 104 for different categories of parts. The user classification component 114 can differentiate between these parts contexts and assign appropriate user classifications for the different parts categories, either across applications or for each application.

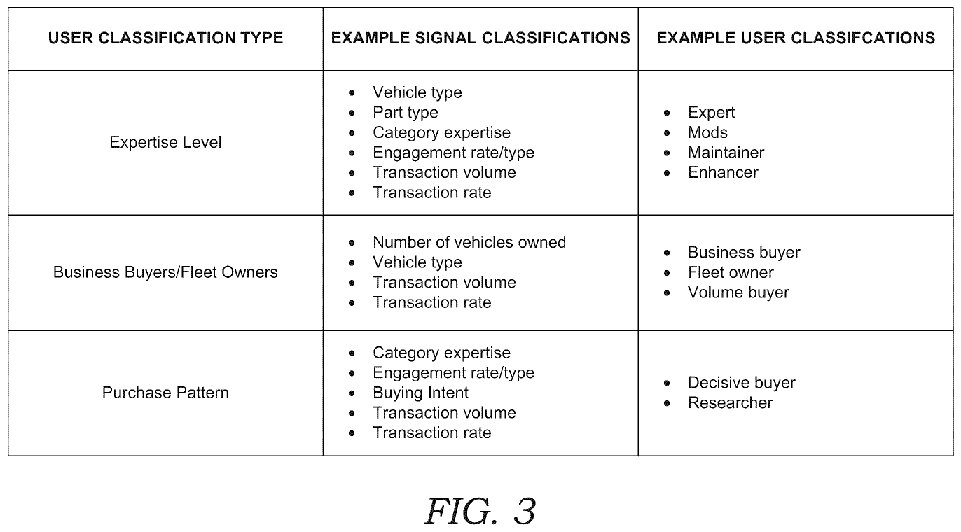

By way of illustration, FIG. 3 provides a diagram showing examples of different types of user classifications for buyer users that can be determined by the user classification component 114 based on different types of classified signal data in the context of vehicles and vehicle parts. As can be seen from the examples shown in FIG. 3, a particular user classification can be determined for a buyer user for one or more of the user classification types based on different classified signal data associated with each user classification type. For instance, for an expertise level user classification type, a buyer user could be classified as an expert, mods, maintainer, or enhancer based on one or more of the following classified signal data types: vehicle type, part type, category expertise, engagement rate/type, transaction volume, and transaction rate. The expertise level user classification for the buyer user can be associated with one or more vehicles owned by the buyer user and/or can be associated with one or more parts categories.

The parts experience component 116 leverages the user classification(s) determined for users by the user classification component 114 to select personalized parts experiences on the listing platform 104 for each user. For instance, the parts experience component 116 can use rule-based algorithms. The rules used by the parts experience component 116 can be accessed from the rules data store 124 or the rules can be embedded in the code of the parts experience component 116. Each rule defines one or more user classifications that result in a given parts experience. When the parts experience component 116 selects a particular personalized parts experience for a given user, the parts experience component 116 instructs one or more application servers of the listing platform 104 to provide the selected personalized parts experience to a user device of the user.

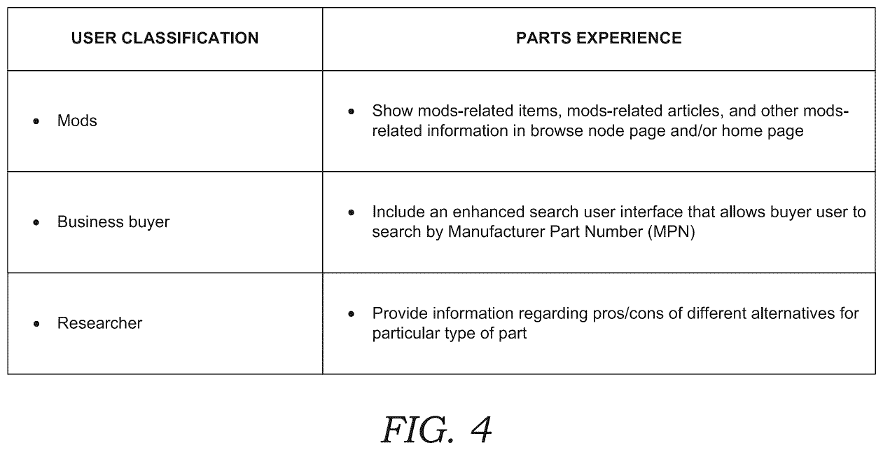

A variety of different parts experiences can be provided. FIG. 4 provides some examples of parts experiences that can be provided to buyer users for certain user classifications in the context of vehicles and vehicle parts. Some personalized parts experiences can include selecting certain content to present to the user based on the user classification(s) for the user. This could include, for instance, employing the user classifications to impact search results, item recommendations, articles, and/or other information that is provided by the listing platform 104 for presentation to the user. By way of example, as shown in FIG. 4, for a buyer user that has been assigned a “mods” user classification, the parts experience component 116 can determine to provide a parts experience that involves showing mods-related items, mods-related articles, and other mods-related information in a browse node page and/or a home page presented to the buyer user. As another example in FIG. 4, for a buyer user that has been assigned a “researcher” user classification, the parts experience component 116 can determine to provide a parts experience that involves providing information regarding pros and cons of different alternatives for a particular type of item to assist the buyer user in more quickly and efficiently finding an item to purchase.

Some personalized parts experiences can include selecting certain user interface elements for inclusion on user interfaces provided to the user and/or giving the user access to certain features on the listing platform 104 that may not be available to all users. For example, as shown in FIG. 4, for a buyer user who has been assigned a “business buyer” user classification, the parts experience component 116 can determine to provide a personalized parts experience that involves including an enhanced search user interface that allows the buyer user to search by Manufacturer Part Number (MPN).

While FIG. 4 provides examples of a single parts experience for each user classification, in some aspects, a given user classification can result in selection of a combination of parts experiences. For example, a user classified as a “vintage car expert” could be provided item recommendations for rare parts, articles on restoration techniques, and specialized search functions; while a user classified as a “commuter car maintainer” could be provided maintenance tips and routine service reminders.

The parts experience component 116 can also dynamically adjust the personalized parts experience provided to a given user based on that user's current context on the listing platform 104. This can occur, for instance, when a user has different user classifications associated with different applications and/or different parts. For a given user with different user classifications, the parts experience component 116 can determine one or more of those user classifications as currently relevant based on the user's current context on the listing platform 104, and the parts experience component 116 can then determine one or more personalized parts experiences to provide based on those currently-relevant user classifications. The user's current context on the listing platform 104 is based on data regarding recent user behavior of the user on the listing platform 104 during a current session (e.g., search queries submitted, items viewed, application selected by user etc.). For example, suppose a buyer user who owns a vintage car and a commuter car has been assigned both a “vintage care expert” user classification and a “commuter car maintainer” user classification. When the buyer user is browsing for parts associated with their vintage car, the parts experience component 116 determines to provide a personalize parts experience based on the “vintage care expert” user classification. When the buyer user is browsing for parts associated with their commuter car, the parts experience component 116 determines to provide a personalized parts experience based on the “commuter care maintainer” user classification.

The listing platform 104 further includes a user interface component 118 that provides one or more user interfaces for interacting with the listing platform 104. The user interface component 118 provides one or more user interfaces to user devices, such as the user device 102. In some instances, the user interfaces can be presented on the user device 102 via the application 108, which can be a web browser or a dedicated application for interacting with the listing platform 104. Among other things, the user interface component 118 provides user interfaces to users to provide the personalized parts experiences selected by parts experience component 116 based on user classifications for the users.

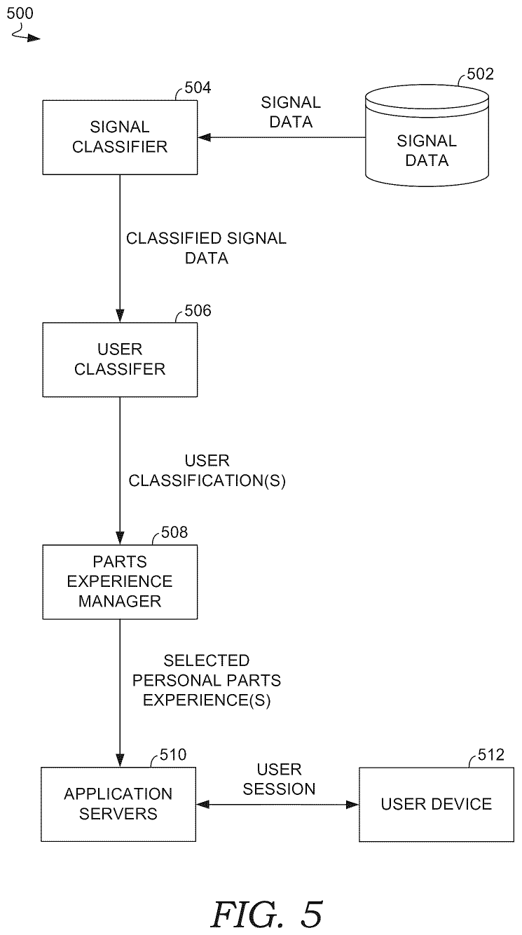

Turning next to FIG. 5, a block diagram is provided illustrating an overall process 500 for providing a personalized parts experience to a user of a listing platform (e.g., a buyer user or a seller user). As shown in FIG. 5, signal data for a user is accessed from a signal data store 502 (which can correspond to the signal data store 122 of FIG. 1). Based on the signal data for the user, a signal classifier 504 (which can correspond to the signal classification component 112 of FIG. 1) classifies the signal data to provide classified signal data. The signal classifier 504 can use a variety of different techniques, including rules-based algorithms and/or machine learning models, to classify the signal data.

The classified signal data is provided to a user classifier 506 (which can correspond to the user classification component 114 of FIG. 1). The user classifier 506 determines one or more user classifications for the user based on the signal classifications. The user classifier 506 can use a variety of different techniques, including rules-based algorithms and/or machine learning models, to determine the user classification(s) from the classified signal data.

The user classification(s) are employed by a parts experience manager 508 (which can correspond to the parts experience component 116 of FIG. 1) to determine one or more personalized parts experiences on the listing platform to provide to the user. When the user has different user classifications associated with different applications and/or parts, the parts experience manager 508 can select personalized parts experience(s) based on one or more user classifications relevant to the user's current context on the listing platform (e.g., based on the user's recent actions - e.g., an explicit selection of a particular vehicle from multiple vehicles owned by the user, search queries submitted, items viewed, etc.). Application servers 510 of the listing platform are instructed to provide the selected personalized parts experience(s) to a user device 512 of the user during a user session involving interaction between the user device 512 and the application servers 510 of the listing platform. In some cases, the personalized parts experiences can change over the course of a user session as the user's context changes (e.g., searching for parts for a vintage car, followed by searching for parts for a commuter car).

Example Method for Personalized Parts Experience on a Listing Platform

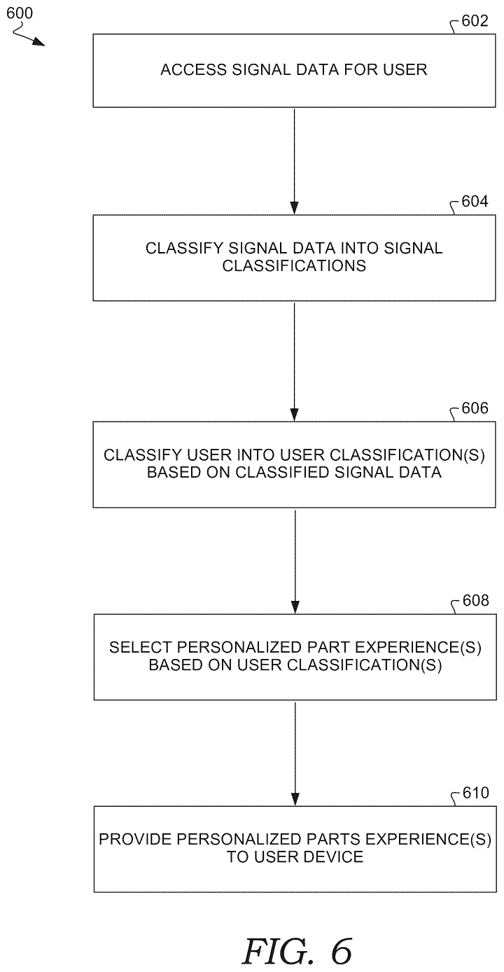

With reference now to FIG. 6, a flow diagram is provided that illustrates a method 600 for providing a personalized parts experience to a user of a listing platform. The method 600 can be performed, for instance, by components of the listing platform 104 of FIG. 1. Each block of the method 600 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 602, signal data is accessed for a user of a listing platform (e.g., a buyer user or a seller user). The signal data can include, for instance, information about user interactions on the listing platform associated with one or more parts and/or one or more applications. The signal data can include information explicitly provided by the user to the listing platform, such as, for instance, a vehicle (i.e., application) owned by the user. The signal data can also include user behavior information on the listing platform for the user, such as, for instance, search queries submitted, items viewed, and items purchased, to name a few.

Signal classifications for the signal data are determined at block 604 to provide classified signal data for the user. The classification of the signal data can be performed using one or more rules and/or one or more signal classifier models. In some aspects, different portions of the classified signal data can correspond to different applications and/or different parts.

As shown at block 606, one or more user classifications for the user are determined based on the classified signal data. The user classifications can be determined based on the classified signal data using one or more rules and/or one or more user classifier models. In some instances, a user classification can be determined based on a combination of multiple types of classified signal data. In some aspects, different user classifications for the user can be determined for different applications and/or different parts based on different portions of the classified signal data.

One or more personalized parts experience are selected for the user based on at least one user classification for the user, as shown at block 608. When the user has multiple different user classifications (e.g., different user applications for different applications and/or parts), the process can involve selecting one or more of those user classifications, for instance based on a current context of the user on the listing platform, and then select a personalized parts experience for the selected user classification(s).

As shown at block 610, one or more application servers of the listing platform provide the selected personalized parts experience(s) to the user device of the user. This can include, for instance, the application server(s) configuring one or more user interfaces for display on the user's device based on the selected personalized parts experience(s). This configuration can include, for instance, selecting content for presentation on the user interfaces (e.g., items to include in search results or item recommendations, manuals, instructions, information about a part, etc.), choosing user interface elements based on the user classification(s), and/or providing access to features of the listing platform through the user interfaces.

### Exemplary Operating Environment

Having described implementations of the present disclosure, an exemplary operating environment in which embodiments of the present technology can be implemented is described below in order to provide a general context for various aspects of the present disclosure. Referring initially to FIG. 7 in particular, an exemplary operating environment for implementing embodiments of the present technology is shown and designated generally as computing device 700. Computing device 700 is but one example of a suitable computing environment and is not intended to suggest any limitation as to the scope of use or functionality of the technology. Neither should the computing device 700 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what can be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 7 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory can be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which can be built in. Illustrative components include a microphone, joystick, game pad, satellite dish, scanner, printer, wireless device, etc. The I/O components 720 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 700. The computing device 700 can be equipped with depth cameras, such as, stereoscopic camera systems, infrared camera systems, RGB camera systems, and combinations of these for gesture detection and recognition. Additionally, the computing device 700 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
accessing, for a user of a listing platform, signal data from a plurality of user interactions on the listing platform associated with one or more parts and/or one or more applications;
determining a plurality of signal classifications for the signal data to provide classified signal data for the user;
determining one or more user classifications for the user based on the classified signal data;
selecting a personalized parts experience for the user based on at least one user classification from the one or more user classifications; and
causing one or more application servers of the listing platform to provide the personalized parts experience to a user device of the user via one or more user interfaces presented on the user device.

2. The one or more computer storage media of claim 1, wherein the signal data comprises information identifying one or more items owned by the user and user behavior information for the user on the listing platform.

3. The one or more computer storage media of claim 1, wherein the plurality of signal classifications are determined for the signal data using one or more rules and/or one or more signal classifier models.

4. The one or more computer storage media of claim 1, wherein the one or more user classifications are determined from the classified signal data using one or more rules and/or one or more user classifier models.

5. The one or more computer storage media of claim 1, wherein a first user classification from the one or more user classifications is determined using a first portion of the classified signal data having a first signal classification and a second portion of the classified signal data having a second signal classification.

6. The one or more computer storage media of claim 1, wherein the one or more user classifications for the user comprise a first user classification for a first application owned by the user and a second user classification for a second application owned by the user; and wherein the personalized parts experience for the user is selected using the first user classification based on a current context of the user on the listing platform corresponding to the first application.

7. The one or more computer storage media of claim 6, wherein the operations further comprise:
selecting a second personalized parts experience for the user using the second user classification based on a subsequent context of the user on the listing platform corresponding to the second application; and
configuring one or more additional user interfaces for display on the user device of the user based on the second personalized parts experience.

8. The one or more computer storage media of claim 1, wherein the one or more user classifications for the user comprise a first user classification for a first type of part and a second user classification for a second type of part; and wherein the personalized parts experience for the user is selected using the first user classification based on a current context of the user on the listing platform corresponding to the first type of part.

9. The one or more computer storage media of claim 8, wherein the first type of part and the second type of part are associated with an application owned by the user.

10. The one or more computer storage media of claim 1, wherein causing the one or more application servers of the listing platform to provide the personalized parts experience to the user device of the user comprises causing the one or more application servers to employ the at least one user classification to select content for presentation on the one or more user interfaces.

11. The one or more computer storage media of claim 1, wherein causing the one or more application servers of the listing platform to provide the personalized parts experience to the user device of the user comprises causing the one or more application servers to provide one or more user interface elements on the one or more user interfaces based on the at least one user classification.

12. The one or more computer storage media of claim 1, wherein causing the one or more application servers of the listing platform to provide the personalized parts experience to the user device of the user comprises causing the one or more application servers to provide, via the one or more user interfaces, access to one or more features of the listing platform based on the at least one user classification.

13. A computer-implemented method comprising:
classifying signal data from one or more user interactions of a user with a listing platform to provide classified signal data, wherein the signal data is associated with one or more parts and/or one or more applications;
processing the classified signal data using one or more rules and/or one or more user classifier models to determine a plurality of user classifications for the user;
selecting a first user classification from the plurality of user classifications;
selecting a personalized parts experience based on the first user classification; and
configuring one or more application servers of the listing platform to provide the personalized parts experience to a user device of the user.

14. The computer-implemented method of claim 13, wherein the method further comprises:
determining a current context of the user on the listing platform, wherein the first user classification is selected based on the current context.

15. The computer-implemented method of claim 14, wherein the plurality of user classifications comprise the first user classification for a first application owned by the user and a second user classification for a second application owned by the user, wherein the first user classification is selected based on the current context corresponding to the first application.

16. The computer-implemented method of claim 14, wherein the plurality of user classifications comprise the first user classification for a first type of part and a second user classification for a second type of part, wherein the first user classification is selected based on the current context correspond to the first type of part.

17. The computer-implemented method of claim 16, wherein the first type of part and the second type of part are compatible with a first application owner by the user.

18. A computer system comprising:
a processor; and
a computer storage medium storing computer-useable instructions that, when used by the processor, causes the computer system to perform operations comprising:
accessing signal data from one or more user interactions of a user with a listing platform, wherein the signal data is associated with one or more parts and/or one or more applications;
processing the signal data using one or more signal classification rules and/or one or more signal classifier models to provide classified signal data;
processing the classified signal data using one or more user classification rules and/or one or more user classifier models to determine a plurality of user classifications for the user;
determining a current context of the user on the listing platform;
selecting a first user classification from the plurality of user classifications based on the current context;
selecting a personalized parts experience based on the first user classification; and
providing the personalized parts experience to a user device of the user via one or more user interfaces presented on the user device.

19. The computer system of claim 18, wherein the plurality of user classifications comprise the first user classification for a first application owned by the user and a second user classification for a second application owned by the user; and wherein the first user classification is selected based on determining the current context of the user is associated with the first application.

20. The computer system of claim 18, wherein the plurality of user classifications comprise the first user classification for a first type of part and a second user classification for a second type of part; and wherein the first user classification is selected based on determining the current context of the user is associated with the first type of part.
